(19) United States
(12) Patent Application Publication
(10) Pub. No.: US 2024/0336001 A1
(43) Pub. Date: Oct. 10, 2024

(54) METHOD AND PLANT FOR SHAPING TUBES OF POLYMERIC MATERIAL

(71) Applicant: Dynamic Technologies S.P.A., Attimis (IT)

(72) Inventors: Giuseppe PECORARO, Attimis (IT); Mauro GIORGINI, Attimis (IT); Albert FERRO, Attimis (IT)

(73) Assignee: Dynamic Technologies S.P.A., Attimis (IT)

(21) Appl. No.: 18/573,356

(22) PCT Filed: Jun. 21, 2022
(86) PCT No.: PCT/IT2022/050177

§ 371 Date: Dec. 21, 2023

(30) Foreign Application Priority Data
Jun. 22, 2021 (IT) 102021000016370

(51) Int. Cl. B29C 53/84; B29C 53/08; B29K 81/00; B29L 23/00

(52) U.S. Cl. CPC B29C 53/84; B29C 53/083; B29K 2081/04; B29L 2023/22

(57) ABSTRACT

Method (10) for shaping tubes of polymeric material comprising a supply step (20) in which a substantially straight tube (T) is provided and a bending step (40) in which the tube (T) is bent to give it a predetermined final shape using a computer numerical control bending machine.

### FIELD OF APPLICATION

The present invention relates to a method for shaping tubes of polymeric material, preferably thermoplastic, which can find application, for example but without general limits, in the field of tube production for the automotive industry.

### BACKGROUND ART

It is known that vehicles, whether they are cars, road or agricultural tractors, vans, etc., need an on-board cooling system to cool their components which overheat during use.

Such a need applies to both traditional vehicles with internal combustion engines and to hybrid or electric vehicles provided with electric motors and specialized batteries for powering the latter.

Generally, the cooling system of a vehicle comprises a hydraulic circuit also formed by a set of tubes which, to be compatible with the arrangement of the other components inside the vehicle, have very complex shapes and are bent several times, even in the three directions of space.

The aforesaid tubes are normally made of poly-phenylene sulfide (PPS) and, to date, their complex shape is conferred thereto through a manual shaping method which includes:
a step of preheating a straight tube of polymeric material;
a manual bending or pre-shaping step of the preheated tube to insert it in a shaping template having a seat mating in shape with the final shape to be conferred to the tube itself;
a crystallization step in which the shaping template, with the pre-shaped tube therein, is arranged in a heated oven for the purposes of the actual shaping;
after the template has been removed from the oven, a cooling step in which the tube, once shaped, is removed from the template and immersed in water.

A drawback of the known manual method is that, in order to be able to manually bend the straight tube so as to insert it in the shaping template, it is necessary to preheat it for a rather long time, even a few minutes.

Furthermore, it is also known that the crystallization step, and in particular the stationing time of the shaping template, and the tube, inside the oven, lasts between and 20 minutes.

For these drawbacks, the known method has the disadvantage of having a low hourly productivity and a rather high cost, as it requires a specialized operator for tens of minutes. These disadvantages translate into a high final cost of the shaped tube.

Therefore, there is a need to improve a shaping method of tubes of polymeric material which can overcome at least one, better if all, of the drawbacks of the prior art.

In particular, an object of the present invention is to develop a method, and provide a plant, for shaping tubes of polymeric material having a high hourly productivity.

Another object of the present invention is to provide a method, and to provide a plant, for shaping tubes of polymeric material which is easily repeatable and which has few, if any, manual steps.

The Applicant has studied, tested and realized the present invention to overcome the drawbacks of the prior art, and to obtain the above as well as further objects and benefits.

### DISCLOSURE OF THE INVENTION

The present invention is expressed and characterized in the independent claims. The dependent claims show other features of the present invention or variants of the main solution proposed.

In accordance with the aforesaid objects, a method for shaping tubes of polymeric material, according to the present invention, a bending step in which the aforesaid tube is bent in accordance with a predetermined final shape.

In accordance with an aspect of the present invention, said bending step is performed by bending and shaping said tube using a computer numerical control bending machine.

In accordance with another aspect of the present invention, the aforesaid method, before the bending step, also includes a preheating step in which the aforesaid tube is brought to a temperature between about 90° C. and about 120° C. for a time between about 25 seconds and about 45 seconds.

In accordance with another aspect of the present invention, the aforesaid method, after the bending step, also includes a crystallization step in which the aforesaid tube is brought to a temperature between about 220° C. and about 230° C. for a time between about 110 seconds and about 130 seconds.

In accordance with another aspect of the present invention, the aforesaid method, after the crystallization step, also includes a stabilization step in which the aforesaid tube is brought to a temperature between about 20° C. and about 30° C. for a time between about 110 seconds and about 130 seconds.

In accordance with another aspect of the present invention, the aforesaid tube provided in the supply step is made of thermoplastic polymeric material, preferably of poly-phenylene sulfide.

The present invention also relates to a plant for shaping tubes of polymeric material comprising a supply station configured to provide a tube of polymeric material and a bending station.

In accordance with a further aspect of the present invention, the aforesaid bending station comprises a computer numerical control bending machine having at least one bending head configured to act on the external surface of the aforesaid tube to perform a bend and positioning means configured to determine both an axial movement of the aforesaid tube towards the aforesaid bending head, and a rotation thereof during the bending steps performed by the aforesaid bending head. The aforesaid plant also comprises a possible crystallization station provided with heating means configured to be brought to a temperature between about 220° C. and about 230° C. for a time between about 110 seconds and about 130 seconds.

In accordance with another aspect of the present invention, the aforesaid plant also comprises a stabilization station comprising cooling means configured to be brought to a temperature between about 20° C. and about 30° C. for a time between about 110 seconds and about 130 seconds.

In accordance with another aspect of the present invention, at least one of the aforesaid heating means and the aforesaid cooling means comprises a mould having two shells defining between them a seat having a shape conjugate with the final shape of the aforesaid bent tube.

In accordance with another aspect of the present invention, the aforesaid plant further comprises a preheating station comprising preheating means configured to be brought to a temperature between about 90° C. and about 120° C. for a time between about 25 seconds and about 45 seconds.

In accordance with another aspect of the present invention, said computer numerical control bending machine further comprises a bending core suitable for being arranged inside the aforesaid tube, configured to contrast the action of said bending head from the inside of the aforesaid tube and possibly also to be heated to a temperature between about 90° C. and about 120° C.

In accordance with another aspect of the present invention, the aforesaid plant also comprises automatic movement means configured to automatically move the aforesaid tube between the aforesaid stations. In embodiments, the aforesaid movement means comprise at least one robotic arm provided with gripping means configured to selectively grip the aforesaid tube.

The present invention also relates to the use of a computer numerical control bending machine for performing a method for shaping tubes of polymeric material comprising a bending step in which a tube of polymeric material is bent and shaped in accordance with a predetermined final shape.

### ILLUSTRATION OF THE DRAWINGS

These and other aspects, features and advantages of the present invention will become clear from the disclosure of some embodiments, provided merely by way of non-limiting example, with reference to the attached drawings in which:

FIG. 1 is a block diagram of an embodiment of the method for shaping tubes of polymeric material according to the present invention;

FIG. 2 is a schematic depiction of an embodiment of a plant for shaping tubes of polymeric material according to the present invention.

It should be noted that in the present description the phraseology and terminology used, as well as the figures of the attached drawings also as described, have the sole function of illustrating and better explaining the present invention, having a non-limiting exemplary function of the invention itself, the scope of protection being defined by the claims.

To facilitate understanding, identical reference numbers have been used, where possible, to identify identical common elements in the figures. It should be noted that elements and features of an embodiment can be conveniently combined or incorporated into other embodiments without further clarification.

### DESCRIPTION OF SOME EMBODIMENTS OF THE PRESENT INVENTION

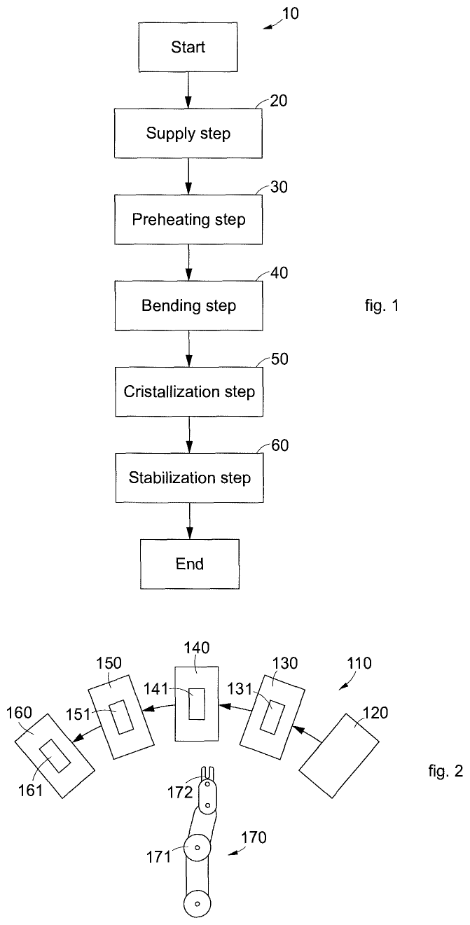

With reference to FIG. 1, a method 10, according to the present invention, is suitable for shaping tubes T of polymeric material intended, for example, but not limitedly, for the automotive industry.

The method 10 comprises a supply step 20 which includes providing a tube T of polymeric material of substantially straight shape. The length of the tube T is preferably at least equal to the extension in plan of a predetermined final bent shape which is to be conferred thereto.

Preferably, the tube T which is provided is of thermoplastic polymeric material, even more preferably it is of poly-phenylene sulfide, also known as “PPS”.

Subsequently, the method 10 includes an optional preheating step 30, in which the tube T is brought to a temperature between about 90° C. and about 120° C. for a time between about 25 seconds and about 45 seconds.

The preheating step 30 has the purpose of heating the tube T to make it advantageously more flexible for the subsequent steps of the method 10.

According to an aspect of the present invention, the method 10 comprises a bending step 40 which includes bending the tube T by means of a computer numerical control bending machine.

The use of the computer numerical control bending machine is particularly advantageous in that it allows to considerably reduce the duration of the bending step 40 and to make it easily repeatable. Furthermore, the use of the computer numerical control bending machine allows to reduce, with respect to the prior art, also the duration and the working temperature of the eventual preheating step 30.

After the bending step 40, the method includes arranging the bent tube T in thermal conditioning means 111 comprising at least one mould having two shells defining between them a seat mating in shape with the final shape of the bent tube T.

For example, after the bending step 40, the method includes a crystallization step 50 in which the bent tube T is brought to a temperature between about 210° C. and about 240° C., preferably between about 220° C. and about 230° C., for a time between about 110 seconds and about 130 seconds. The crystallization step 50 is preferably performed by arranging the bent tube T in heating means 151, comprised in said thermal conditioning means 111, and which will be described in detail below.

The crystallization step 50 has the purpose of heating the tube T to trigger and catalyse the crystallization of the polymeric material of which it is formed.

Preferably, after the crystallization step 50, a stabilization step 60 is included in which the tube T is brought to a temperature between about 20° C. and about 30° C. for a time between about 110 seconds and about 130 seconds.

The stabilization step 60 is preferably performed by arranging the bent tube T in cooling means 151, also comprised in said thermal conditioning means 111, and which will be described in detail below.

The stabilization step 60 has the purpose of subjecting the tube T to a controlled reduction in temperature to consolidate its final bent shape.

Referring to FIG. 2, the present invention also relates to a plant 110 for shaping tubes of polymeric material comprising at least one supply station 120 in which the aforesaid supply step 20 is performed and a bending station 140 in which the aforesaid bending step 40 is performed.

In particular, according to a further aspect of the present invention, the bending station 140 comprises a computer numerical control bending machine 141 which in turn comprises at least one bending head configured to act on the external surface of the tube T to perform a bending, a possible bending core suitable to be arranged inside the tube T and configured to contrast the action of the bending head from the inside, and positioning means configured to determine both an axial movement of the tube T towards the bending head, and a rotation thereof about its longitudinal axis.

In embodiments, the aforesaid bending core can also be configured to heat to a temperature between about 90° C. and about 120° C.

Moreover, in some embodiments, the plant 110 can comprise an optional preheating station 130, in which said preheating step 30 is performed, and which comprises preheating means 131 configured to be brought to a temperature between about 90° C. and about 120° C. for a time between about 25 seconds and about 45 seconds.

In particular, the preheating means 131 comprise a metal mould, configured to be heated by an electrical resistance, and essentially consisting of two shells defining a substantially straight seat between them in which, in use, the tube T is arranged.

The plant 110 further comprises thermal conditioning means 111 comprising at least one mould having two shells defining between them a seat mating in shape with the final shape of the bent tube T.

In the embodiments described herein, the thermal conditioning means 111 comprise both heating means 151 and cooling means 161.

In particular, the plant 110 also comprises a crystallization station 150 in which the aforesaid crystallization step 50 is performed and which comprises the heating means 151. The heating means 151 are configured to be brought to a temperature between about 210° C. and about 240° C., preferably between about 220° C. and about 230° C., for a time between about 110 seconds and about 130 seconds.

In particular, the heating means 151 comprise a metal mould, configured to be heated by an electrical resistance, and essentially consisting of two shells defining between them a seat having a conjugate shape with the final shape of the bent tube T.

The plant 110 also comprises a stabilization station 160 in which the aforesaid stabilization step 60 is performed and which comprises the cooling means 161. The cooling means 161 are configured to be brought to a temperature between about 20° C. and about 30° C. for a time between about 110 seconds and about 130 seconds.

In particular, the cooling means 161 comprise a metal mould, configured to be water-cooled and/or air-cooled, also essentially consisting of two shells defining between them a seat having a conjugate shape with the final shape of the bent tube T.

Optionally, the mould of the heating means 151 is the same shell as the mould of the cooling means 161 and is configured to be both heated by an electric resistor and to be water and/or air-cooled.

Preferably, the plant 110 also comprises automatic movement means 170 configured to move the tube T from one station to the next according to a predetermined scheme, in accordance with the method 10 of the present invention.

In embodiments, the movement means 170 comprise at least one robotic arm 171 provided with gripping means 172 configured to grip a tube T arranged in one of the aforesaid stations and to hold it during the movement towards a subsequent station.

It is clear that modifications and/or additions of parts or steps can be made to the method 10 and to the plant 110 described so far, without departing from the scope of the present invention as defined by the claims.

It is also clear that, although the present invention has been described with reference to some specific examples, a person skilled in the art will be able to make many other equivalent forms of methods and plants for shaping tubes of polymeric material, having the features expressed in the claims and therefore all of which falling within the scope of protection defined thereby.

In the following claims, the references in parentheses have the sole purpose of facilitating reading and must not be considered as limiting factors of the scope of protection defined by the claims themselves.

1. A method (10) for shaping tubes of a polymeric material, said method comprising:
a bending step (40) in which a tube (T) of the polymeric material is bent and shaped in accordance with a predetermined final shape, wherein said bending step (40) is performed by bending and shaping said tube (T) using a computer numerical control bending machine (141) to produce a bent tube (T), and
arranging said bent tube (T) in a thermal conditioning means (111) comprising at least one mould having two shells, wherein the two shells are defined by a seat mating in a shape with the predetermined final shape of said tube (T).

2. The method (10) of claim 1, wherein, before the bending step (40), said method further comprises a preheating step (30) in which said tube (T) is brought to a first temperature between about 90° C. and about 120° C. for a first time between about 25 seconds and about 45 seconds.

3. The method (10) of claim 1, wherein, after the bending step (40), said method further comprises a crystallization step (50) in which said bent tube (T) is brought to a second temperature between about 210° C. and about 240° C., preferably between about 220° C. and about 230° C., for a second time between about 110 seconds and about 130 seconds.

4. The method (10) of claim 3, wherein said method further comprises, after the crystallization step (50), a stabilization step (60) in which said bent tube (T) is brought to a third temperature between about 20° C. and about 30° C. for a third time between about 110 seconds and about 130 seconds.

5. The method (10) of claim 1, wherein said bent tube (T) is made of a thermoplastic polymeric material, in particular poly-phenylene sulfide.

6. A plant (110) for shaping tubes of a polymeric material comprising:
a supply station (120) configured to provide a tube (T) of the polymeric material,
a bending station (140), wherein said bending station (140) comprises a computer numerical control bending machine (141) having at least one bending head configured to act on an external surface of said tube (T) to bend and position said tube (T) to produce a bent tube (T), and configured to determine both an axial movement of said tube (T) towards said bending head, and a rotation thereof about its longitudinal axis, and
a thermal conditioning means (111) comprising one or more moulds each of which has two shells, wherein the two shells are defined by a seat mating in a shape with a final shape of said bent tube (T).

7. The plant (110) of claim 6, wherein said thermal conditioning means (111) comprises both a heating means (151) configured to be brought to a first temperature between about 210° C. and about 240° C., preferably between about 220° C. and about 230° C., for a first time between about 110 seconds and about 130 seconds for a crystallization of said polymeric material, and a cooling means (161) configured to be brought to a second temperature between about 20° C. and about 30° C. for a second time between about 110 seconds and about 130 seconds, for stabilizing the final shape of said tube (T).

8. The plant (110) of claim 7, further comprising a crystallization station (150) provided with said heating means (151).

9. The plant (110) of claim 8, further comprising a stabilization station (160) comprising said cooling means (161).

10. The plant (110) of claim 7 wherein at least one of said heating means (151) and said cooling means (161) comprises a mould having two shells defining between them a seat mating in shape with the final shape of said bent tube (T).

11. The plant (110) of claim 6, wherein said computer numerical control bending machine (141) further comprises a bending core suitable to be arranged inside said tube (T), configured to contrast said bending head from an inside of said tube (T) and possibly also to be heated to a temperature between about 90° C. and about 120° C.

12. The plant (110) of claim 9, further comprising a preheating station (130) comprising preheating means (131) which are configured to be brought to a third temperature between about 90° C. and about 120° C. for a third time between about 25 seconds and about 45 seconds.

13. The plant (110) of claim 12, further comprising an automatic movement means (170) configured to automatically move said tube (T) between said supply station (120), said preheating station (130), said bending station (140), said crystallization station (150), and said stabilization station (160).

14. The plant (110) of claim 13, wherein said automatic movement means (170) comprises at least one robotic arm (171) provided with a gripping means (172) configured to selectively grip said tube (T).

15. Use of a computer numerical control bending machine (141) for carrying out a method (10) for shaping tubes of a polymeric material comprising a bending step (40) in which said tube (T) of the polymeric material is bent and shaped in accordance with a predetermined final shape.
